(19) United States
(12) Patent Application Publication
(10) Pub. No.: US 2003/0120544 A1
(43) Pub. Date: Jun. 26, 2003

(54) International incentive system

(75) Inventors: Ralph Gritzbach, Erlangen (DE); Rainer Kuth, Herzogenaurach (DE); Christoph Zindel, Uttenreuth (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/307,858

(22) Filed: Dec. 2, 2002

(30) Foreign Application Priority Data
Dec. 10, 2001 (DE) 10160531.5

(51) Int. Cl. G06F 17/60

(52) U.S. Cl. 705/14

(57) ABSTRACT

In an incentive system, i.e., a method for organizing and distributing tangible incentives, wherein concerns (incentive providers) grant activity-dependent or sales-dependent premiums to the subscribers in order to promote certain objectives of the concern, the reward system is organized on the basis of securities, particularly stocks.

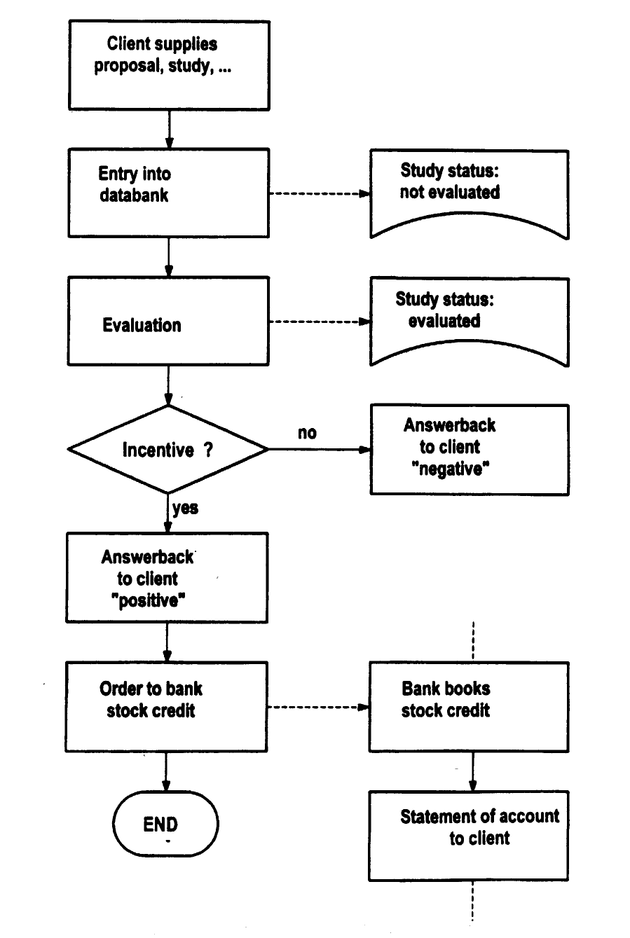

### BACKGROUND OF THE INVENTION

1. Field of the Invention

The present invention is directed to an incentive system, i.e. a method for organizing and distributing tangible incentives of the type, whereby concerns (incentive providers) give activity-dependent or sales-dependent premiums to the subscribers in order to promote certain objectives of the concern.

2. Description of the Prior Art

Incentive systems of this type are currently mainly known from airline companies that have mileage programs, wherein the customer is credited for miles in an account that is administered by the incentive provider as soon as the customer purchases services of the concern. These miles can be collected and cashed. In for valuable services such as free flights and goods. Such free flights and goods from a limited offering, however, are not attractive to all target groups. The booking of free flights and goods is not uncomplicated and the shipping of the goods is complicated because of customs boundaries, warranty demands, tax, etc.

This limitation on incentive systems in the form of mileage programs also fundamentally applies to incentive systems that concerns have developed to reward customers and employees for special duty, especially successful work or the like, when a direct remuneration with money is not feasible and the granting of premiums or incentive trips is not attractive enough for many potential subscribers.

A further disadvantage is that such known incentive systems are always limited to only the single concern as a consequence of the direct administration and the granting of the concern's own services as premiums, and thus a global fashioning of such a system wherein different concerns participate in an incentive system is not meaningfully possible.

### SUMMARY OF THE INVENTION

An object of the present Invention is to provide an Incentive system for which the target group can be arbitrary employees as well as suppliers and customers and that is globally configurable, particularly internationally configurable for different concerns, and which avoids the aforementioned disadvantages of known premium disbursement systems.

This object is achieved in accordance with the invention in an incentive distributing method wherein the rewards system is organized on the basis of securities, particularly stocks or stock options, preferably wherein multiple stocks can be grouped in a securities fund for which share points are awarded.

The organization of an incentive system on the basis of securities instead of premiums or flight miles makes the system interesting for practically every subscriber and also enables a much simpler accounting and reward evaluation of completely different services. The service can be that a customer carries out tests and reports the test results to the concern, and the concern thereby avoids the considerable cost associated with undertaking such investigations on its own. The introduction of reward proposals from outside parties as well as the standard rewarding of customer loyalty can be very well evaluated and attractively rewarded in the inventive incentive system. Even indemnification for employees for special duty and for special work results can be designed very attractively, so as to stimulate such activity with the assistance of an inventive incentive system. Moreover, the organization of such an incentive system with a minimal administrative outlay is attractive to all target groups.

The securities deposit or the securities fund can be maintained by an independent banking house, which in turn makes the accessibility especially desirable for different concerns as well as heightening the attractiveness for the participants in this system, particularly the recipients of the incentive (company employees, suppliers, customers or the like).

As a result of maintaining a direct account for the respective incentive participants at an independent banking house and the direct access to the accumulated securities credit—that, of course, can be provided with certain waiting periods for the transfer as is standard for stock purchases and new issues—the rewarded incentive participant has greater freedom in the management and utilization of his/her premiums.

When maintaining the securities deposit or the securities fund at an independent banking house, the system preferably be designed such that the incentive provider can directly increment the value of an account of a subscriber via a digital access, with the digital access to the respective accounts at the independent banking house embodying a standardized encryption method. This standardized encryption method such as, for example, PGP also can be organized by means of transaction numbers TAN and a checksum. The incrementation of the account of a subscriber should be able to ensue in fractions of shares.

Additionally, the inventive provider can maintain point accounts for the participants, whereby a specific number of points correspond to a fund share and an incrementation of the account at the banking house ensues only when this number of points is reached. This initially Incomplete reward situation represents a particular stimulus for the participants to accomplish further special services and thus obtain further points. Moreover, “small” services can thus also be incorporated into the reward program in this manner.

The invention provides the heretofore-unavailable possibility for an internationally operating concern to internationally pay incentives in a “currency” that is defined by the concern and is attractive to every participant. The current outlay involved in cashing in virtual money, for instance miles, for goods or the like is thereby avoided.

### DESCRIPTION OF THE DRAWINGS

The single FIGURE is a flowchart of an exemplary embodiment of the inventive method on the basis of an incentive system for rewarding clinical studies that radiologists supply to an equipment manufacturer.

### DESCRIPTION OF THE PREFERRED EMBODIMENTS

The incentive subscriber referred to as client in the illustrated exemplary embodiment, for example a radiologist who works with equipment from a specific manufacturer, submits a proposal or a study about working with this equipment. This study is entered into a databank, and this status of the receipt of the aforementioned study is separately acquired and may be reported back to the client.

An evaluation of this study with renewed storing and answerback to the client then ensues. If the evaluation leads to the conclusion that an incentive reward is due, then this may he communicated to the client. Preferably, however, an order is automatically forwarded to the bank for a stock credit or stock fund credit. The bank, which maintains the accounts of the participants in the incentive system independently of the concern—oven though the concern, of course, has direct access via standardized encryption methods in order to directly increment the participant's value on account but not, for example, to decrease it—books this stock credit and sends corresponding account statements to the clients.

Correspondingly, of course, the inventive system can be utilized not only for rewarding special case studies by customers of a concern but also for rewarding special achievements of company employees, or for rewarding “normal” customers for purchases they have made.

An international concern can link its employees throughout the world, who work a large variety of currency zones and also may have place different values on the worth of certain premiums, into a single incentive system in common with suppliers and customers or the like in an attractive way.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for organizing and distributing tangible incentives comprising the steps of:
awarding incentive premiums, selected from the group consisting of activity-dependent premiums and sales-dependent premiums, to subscribers selected from the group consisting of employees of the incentive provider, customers of the incentive provider, and vendors to the incentive provider, based on a reward system; and
organizing said reward system to award securities as said incentive premium.

2. A method as claimed in claim 1 comprising awarding stocks as said incentive premium.

3. A method as claimed in claim 1 comprising awarding a plurality of stocks in a securities fund as said premium.

4. A method as claimed in claim 3 comprising awarding share points in said security fund as said premium.

5. A method as claimed in claim 1 comprising maintaining a deposit of said securities at an independent banking house, independent of said incentive provider.

6. A method as claimed in claim 5 comprising allowing said incentive provider to directly increment a value of an account of a subscriber at said independent banking house to award said incentive premium to said subscriber.

7. A method as claimed in claim 6 comprising allowing digital access to said account by said incentive provider.

8. A method as claimed in claim 7 comprising encrypting said digital access with a standardized encryption algorithm.

9. A method as claimed in claim 1 comprising maintaining a subscriber account for each subscriber, and awarding points to said subscriber account dependent on incentive-based activity by the subscriber associated with the subscriber account, and prescribing a total point number which must be accumulated in subscriber account to credit an award of securities to the subscriber associated with the subscriber account.
